(19) United States
(12) Patent Application Publication
(10) Pub. No.: US 2008/0156857 A1
(43) Pub. Date: Jul. 3, 2008

(54) Method For Forming A Rim And Edge Seal For An Insulating Cup

(75) Inventor: William C. Johnston, Puyallup, WA (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: Weyerhaeuser Co., Federal Way, WA (US)

(21) Appl. No.: 11/617,055

(22) Filed: Dec. 28, 2006

(51) Int. Cl. B65D 3/00; B65D 81/38; B31B 1/00

(52) U.S. Cl. 229/100; 229/403; 493/56

(57) ABSTRACT

A container such as a paper cup is formed from a thick paperboard blank. The blank has a predetermined thickness and has a top edge, side edges, and a bottom edge. The regions adjacent at least one, and preferably all, of the top edge and first and second side edges are compressed along the length thereof. When the regions adjacent the side edges are overlapped, a reduced thickness side seam is formed. When the compressed region adjacent the top edge is curled to form the upper lip, a lip of lesser thickness is formed than otherwise would be formed from the paperboard material.

### BACKGROUND

The present invention relates to paper cups, more particularly to insulated paper cups, and most particularly to a method for forming blanks therefor and for producing paper cups from the blanks.

Insulating paperboard is used for paper cups in applications where the cups are utilized to serve hot liquids. A number of ways to enhance the insulating characteristics of paperboards from which the hot cups are made have been developed. One such paperboard is disclosed in U.S. Pat. No. 7,056,563, issued Jun. 6, 2006, to Donald D. Halabisky and assigned to the Weyerhaeuser Company of Federal Way, Wash. The insulating paperboard of the '563 patent comprises at least one layer having cross-linked fiber therein to enhance the thickness and thus the insulating characteristics of the paperboard.

When paper cups are manufactured, they are manufactured from a single blank which is overlapped along its edge portions and sealed together. In addition, the top portions of the paper cup are curled outwardly and then inwardly to form a lip on the cup. When thicker paperboards are employed, the overlapping edge seam becomes bulky. In addition, the lip has a larger diameter than when conventional paperboard is utilized

### SUMMARY

The present invention provides a blank for producing a container such as a paper cup from insulated paperboard, a method of forming the blank into the paper cup, and the paper cup itself. The blank for the container comprises a paperboard blank having a predetermined thickness. The blank also has side edges, a top edge, and a bottom edge. The blank, adjacent at least one of the side edges and/or the top edge, is compressed to a thickness less than the predetermined thickness of the paperboard blank itself.

The method of forming the container from a paperboard blank comprises forming and cutting a paperboard blank from a sheet of paperboard having a predetermined thickness. The blank has side edges, a top edge, and a bottom edge. Thereafter, the blank is preferably compressed adjacent the top edge to form a strip of paperboard having a thickness less than the predetermined thickness. In its preferred form, the container is formed from a blank in which the blank is also compressed adjacent the side edges of the container to form compressed strips that when overlapped have a total thickness less than twice the predetermined thickness. In addition, the lip of the container is created from a strip of compressed paperboard to provide a final lip having a lesser diameter than would be created from the paperboard of predetermined thickness.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a plan view of a paperboard blank formed in accordance with the present invention;

FIG. 1A is a cross-sectional view of the blank of FIG. 1 taken along section line 1A-1A;

FIG. 2 is a flow diagram of the method of producing a cup in accordance with the present invention;

FIG. 3 is an isometric view of a finished cup;

FIG. 3A is a section of the cup taken along section line 3A-3A;

FIG. 3B is a section line of the cup taken along section line 3B-3B; and

FIG. 4 is a plot of thickness versus time after compression of paperboard in accordance with the present invention.

### DETAILED DESCRIPTION

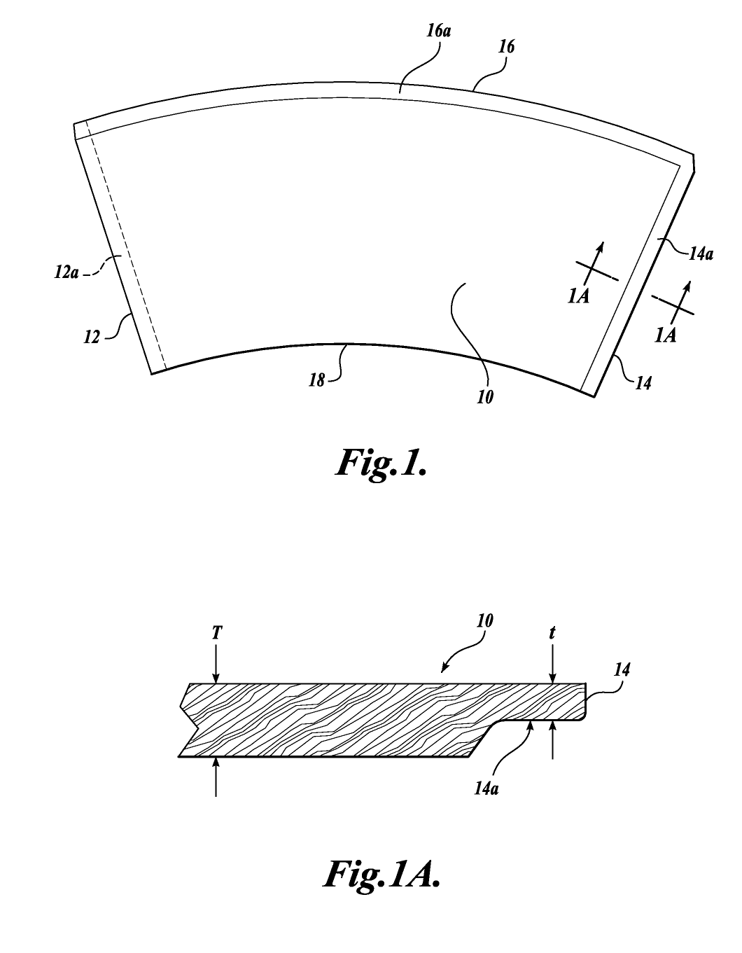

Referring to FIG. 1, the insulating paperboard blank 10 for forming a container such as a paper cup in accordance with the present invention is produced in a conventional manner from readily available fibers such as cellulosic fibers. The paperboard of the present invention can be made in a single-ply, a two-ply, or other multi-ply construction, as desired.

At least one ply of the paperboard, whether a single-ply or a multiple-ply structure, contains cross-linked fibers. The cross-linked fibers increase the bulk density of the paperboard and thus the insulating characteristics. As used herein, cross-linked fibers are kinked, twisted, curly, cellulosic fibers. It is preferred, however, that the fibers be produced by intrafiber crosslinking of the cellulosic fibers as described in more detail below.

Paperboard of the present invention may have a broad set of characteristics. For example, its basis weight can range from 200 gsm to 500 gsm, more preferably, from 250 gsm to 400 gsm. Most preferably, the basis weight of the paperboard is equal to or greater than 250 gsm. To achieve the insulating characteristics of the present invention, it is preferred that the paperboard has a density of less than 0.5 g/cc, more preferably, from 0.3 g/cc to 0.45 g/cc, and most preferably, from 0.35 g/cc to 0.40 g/cc.

When at least one ply of the paperboard contains cross-linked fibers in accordance with the present invention, advantageous temperature drop characteristics can be achieved. These temperature drop characteristics can be achieved by altering the amount of cross-linked fiber introduced into the paperboard, by adjusting the basis weight of the paperboard, by adjusting the caliper of the paperboard after it has been produced by running it, for example, through nip rolls, and of course, by varying the number and thickness of additional plies incorporated in the paperboard structure. It is preferred that this paperboard have a caliper greater than or equal to 0.5 mm, a basis weight equal to or greater than 250 gsm, and a density less than 0.5 g/cc. In a most preferred form, the paperboard of the present invention exhibits a hot water ΔT of 10° C.±2.3° C. at a caliper of 0.64 mm and a hot water ΔT of 14° C.±2.3° C. at a caliper of 1.25 mm. The relationship of hot water ΔT to thickness is a linear one between the calipers of 0.6 mm and 1.25 mm and continues to be linear with a reduction in the caliper below 0.6 mm or an increase above 1.25 mm. Stated another way, a paperboard constructed in accordance with the present invention having a caliper of 0.3 mm or greater will exhibit a hot water ΔT (as defined in U.S. Pat. No. 7,056,563) of 0.7° C.±2.3° C. per 0.1 mm of caliper, and most preferably a hot water ΔT of 0.7° C.±2.0° C.

The paperboard of the invention can be a single-ply product. When a single-ply product is employed, the low density characteristics of the paperboard of the present invention allow the manufacture of a thicker paperboard at a reasonable basis weight. To achieve the same insulating characteristics with a normal paperboard, the normal paperboard thickness would have to be doubled relative to that of the present invention. Using the cross-linked fibers of the present invention, an insulating paperboard having the same basis weight as a normal paperboard can be made. This effectively allows the manufacture of insulating paperboard on existing paperboard machines with minor modifications and minor losses in productivity. Moreover, a one-ply paperboard has the advantage that the whole structure is at a low density. Furthermore, as will be described later, the low density paperboard of the present invention is easily embossable.

Alternatively, the paperboard of the invention can be multi-ply product, and include two, three, or more plies. Paperboard that includes more than a single-ply can be made by combining the plies either before or after drying. It is preferred, however, that a multi-ply paperboard be made by using multiple headboxes arranged sequentially in a wet-forming process, or by a baffled headbox having the capacity of receiving and then laying multiple pulp furnishes. The individual plies of a multi-ply product can be the same or different.

The paperboard of the present invention can be formed using conventional papermaking machines including, for example, Rotofolmer, Fourdrinier, inclined wire Delta former, and twin-wire forming machines.

When a single-ply paperboard is used in accordance with the present invention, it is preferably homogeneous in composition. The single ply, however, may be stratified with respect to composition and have one stratum enriched with cross-linked fibers and another stratum enriched with non-cross-linked fibers. For example, one surface of the paperboard may be enriched with cross-linked fibers to enhance that surface's bulk and the other surface enriched with non-crosslinked fibers to provide a smooth, denser, less porous surface.

It is preferred that a single ply paperboard be homogeneous in composition. The cross-linked fibers are uniformly intermixed with the regular cellulosic fibers. For example, in the headbox furnish it is preferred that the cross-linked fibers present in the insulating ply or layer be present in an amount from about 25% to about 100%, and more preferably from about 30% to about 70%. In a two-ply structure, for example, the first ply may contain 100% non-cross-linked fibers while the second ply may contain from 25% to 100% cross-linked fibers and preferably from 30% to 70% cross-linked fibers. In a three-ply layer, for example, the bottom and top layers may comprise 100% of non-cross-linked fibers while the middle layer contains from about 25% to about 100% and preferably from about 30% to about 70% of cross-linked fibers.

When cross-linked fibers are used in paperboard in accordance with the present invention, it has been found that the paperboard exiting the papermaking machine can be compressed to varying degrees to adjust the temperature drop characteristics across the paperboard. In accordance with the present invention, the paperboard once leaving the papermaking machine may be compressed or reduced in caliper by up to 50%, and more preferably, from 15% to 25%. This adjustment in the caliper of the paperboard made in accordance with the present invention allows the hot water ΔT to be varied as desired. This same result can be achieved by lowering the basis weight of the paperboard.

In addition, the paperboard of the present invention can be embossed with a variety of conventional embossing rollers to produce a paperboard that has a tactile sense to the user quite different from that of the conventional paperboard. An embossed surface not only provides a better gripping surface, but also provides an actual and perceived reduction in the heat transfer from the surface of the paperboard to a person touching the exterior of the paperboard. Flat embossed cauls may also be used to form an embossed pattern on the paperboard. Any of a variety of embossed patterns can be employed. However, when the paperboard is to be employed as a hot cup or other container, it is preferred that a fine pattern of indentations be embossed into the outer surface of the cup so as in essence to provide a multiplicity of small surface indents that effectively reduce the contact surface area for a person touching the surface of the paperboard. This is especially effective when the paperboard is used in a hot cup or other container that is held by a person for any period of time. The reduction in contact area reduces the amount of heat transferred to the person's fingers and thus reduces the sensation of excessive temperature. For example, the number of bumps and depressions in a one centimeter square surface of paperboard might comprise a 6 by 6 array.

The paperboard of the present invention can be utilized to make a variety of structures, particularly containers, in which it is desired to have insulating characteristics. One of the most common of these containers is the ubiquitous hot cup utilized for hot beverages such as coffee, tea, and the like. Other insulating containers such as a noodle cup, a soup cup, or the ordinary paper plate can also incorporate the paperboard of the present invention. Also; carry-out containers conventionally produced of paperboard or of foam material can also employ the paperboard of the present invention. A hot cup type container produced in accordance with the present invention may comprise one or more plies, one of which contains cross-linked fibers. In one embodiment the cross-linked fibers may be in the interior ply. A liquid impervious backing may be laminated to the interior ply. The backing may comprise, for example, a variety of thermoplastic materials, such as polyethylene. It is preferred that the paperboard used in the bottom of the cup contain no cross-linked fibers.

Although available from other sources, noncross-linked cellulosic fibers usable in the present invention are derived primarily from wood pulp. Suitable wood pulp fibers for use with the invention can be obtained from well-known chemical processes such as the kraft and sulfite processes, with or without subsequent bleaching. Pulp fibers can also be processed by thermomechanical, chemithermomechanical methods, or combinations thereof. The preferred pulp fiber is produced by chemical methods. Groundwood fibers, recycled or secondary wood pulp fibers, and bleached and unbleached wood pulp fibers can be used. Softwoods and hardwoods can be used. Details of the selection of wood pulp fibers are well known to those skilled in the art. These fibers are commercially available from a number of companies, including Weyerhaeuser Company, the assignee of the present invention. For example, suitable cellulose fibers produced from southern pine that are usable with the present invention are available from Weyerhaeuser Company under the designations CF416, NF405, FR516, and NB416.

In addition to fibrous materials, the paperboard of the invention may optionally include a binding agent. Suitable binding agents are soluble in, dispersible in, or form a suspension in water. Suitable binding agents include those agents commonly used in the paper industry to impart wet and dry tensile and tearing strength to such products. Suitable wet strength agents include cationic modified starch having nitrogen-containing groups (e.g., amino groups), such as those available from National Starch and Chemical Corp., Bridgewater, N.J.; latex; wet strength resins, such as polyamide-epichlorohydrin resin (e.g., KYMENE 557LX, Hercules, Inc., Wilmington, Del.), and polyacrylamide resin (see, e.g., U.S. Pat. No. 3,556,932 and also the commercially available polyacrylamide marketed by American Cyanamid Co., Stanford, Conn., under the trade name PAREZ 631 NC); urea formaldehyde and melamine formaldehyde resins; and polyethylenimine resins. A general discussion on wet strength resins utilized in the paper field, and generally applicable in the present invention, can be found in TAPPI monograph series No. 29, “Wet Strength in Paper and Paperboard”, Technical Association of the Pulp and Paper Industry (New York, 1965).

Other suitable binding agents include starch, modified starch, polyvinyl alcohol, polyvinyl acetate, polyethylene/acrylic acid copolymer, acrylic acid polymers, polyacrylate, polyacrylamide, polyamine, guar gum, oxidized polyethylene, polyvinyl chloride, polyvinyl chloride/acrylic acid copolymers, acrylonitrile/butadiene/styrene copolymers, and polyacrylonitrile. Many of these will be formed into latex polymers for dispersion or suspension in water.

The preferred cross-linked fibers for use in the invention are crosslinked cellulosic fibers. Any one of a number of crosslinking agents and crosslinking catalysts, if necessary, can be used to provide the crosslinked fibers to be included in the layer. The following is a representative list of useful crosslinking agents and catalysts. Each of the patents noted below is expressly incorporated herein by reference in its entirety.

Suitable urea-based crosslinking agents include substituted ureas, such as methylolated ureas, methylolated cyclic ureas, methylolated tower alkyl cyclic ureas, methylolated dihydroxy cyclic ureas, dihydroxy cyclic ureas, and lower alkyl substituted cyclic ureas. Specific urea-based crosslinking agents include dimethyldihydroxy urea (DMDHU, 1,3-dimethyl-4,5-dihydroxy-2-imidazolidinone), dimethyloldihydroxyethylene urea (DMDHEU, 1,3-dihydroxymethyl-4,5-dihydroxy-2-imidazolidinone), dimethylol urea (DMU, bis[N-hydroxymethyl]urea), dihydroxyethylene urea (DHEU, 4,5-dihydroxy-2-imidazolidinone), dimethylolethylene urea (DMEU, 1,3-dihydroxymethyl-2-imidazolidinone), and dimethyldihydroxyethylene urea (DMeDHEU or DDI, 4,5-dihydroxy-1,3-dimethyl-2-imidazolidinone).

Suitable crosslinking agents include dialdehydes such as C₂-C₈ dialdehydes (e.g., glyoxal), C₂-C₈ dialdehyde acid analogs having at least one aldehyde group, and oligomers of these aldehyde and dialdehyde acid analogs, as described in U.S. Pat. Nos. 4,822,453; 4,888,093; 4,889,595; 4,889,596; 4,889,597; and 4,898,642. Other suitable dialdehyde crosslinking agents include those described in U.S. Pat. Nos. 4,853,086; 4,900,324; and 5,843,061. Other suitable crosslinking agents include aldehyde and urea-based formaldehyde addition products. See, for example, U.S. Pat. Nos. 3,224,926; 3,241,533; 3,932,209; 4,035,147; 3,756,913; 4,689,118; 4,822,453; 3,440,135; 4,935,022; 3,819,470; and 3,658,613. Suitable crosslinking agents may also include glyoxal adducts of ureas, for example, U.S. Pat. No. 4,968,774, and glyoxal/cyclic urea adducts as described in U.S. Pat. Nos. 4,285,690; 4,332,586; 4,396,391; 4,455,416; and 4,505,712.

Other suitable crosslinking agents include carboxylic acid crosslinking agents such as polycarboxylic acids. Polycarboxylic acid crosslinking agents (e.g., citric acid, propane tricarboxylic acid, and butane tetracarboxylic acid) and catalysts are described in U.S. Pat. Nos. 3,526,048; 4,820,307; 4,936,865; 4,975,209; and 5,221,285. The use of C₂-C₉ polycarboxylic acids that contain at least three carboxyl groups (e.g., citric acid and oxydisuccinic acid) as crosslinking agents is described in U.S. Pat. Nos. 5,137,537; 5,183,707, 5,190,563; 5,562,740; and 5,873,979.

Polymeric polycarboxylic acids are also suitable crosslinking agents. Suitable polymeric polycarboxylic acid crosslinking agents are described in U.S. Pat. Nos. 4,391,878; 4,420,368; 4,431,481; 5,049,235; 5,160,789; 5,442,899; 5,698,074; 5,496,476; 5,496,477; 5,728,771; 5,705,475; and 5,981,739. Polyacrylic acid and related copolymers as crosslinking agents are described U.S. Pat. Nos. 5,549,791 and 5,998,511. Polymaleic acid crosslinking agents are described in U.S. Pat. No. 5,998,511 and U.S. application Ser. No. 09/886,821.

Specific suitable polycarboxylic acid crosslinking agents include citric acid, tartaric acid, malic acid, succinic acid, glutaric acid, citraconic acid, itaconic acid, tartrate monosuccinic acid, maleic acid, polyacrylic acid, polymethacrylic acid, polymaleic acid, polymethylvinylether-co-maleate copolymer, polymethylvinylether-co-itaconate copolymer, copolymers of acrylic acid, and copolymers of maleic acid. Other suitable crosslinking agents are described in U.S. Pat. Nos. 5,225,047; 5,366,591; 5,556,976; and 5,536,369.

Suitable crosslinking catalysts can include acidic salts, such as ammonium chloride, ammonium sulfate, aluminum chloride, magnesium chloride, magnesium nitrate, and alkali metal salts of phosphorous-containing acids. In one embodiment, the crosslinking catalyst is sodium hypophosphite.

The crosslinking agent is applied to the cellulosic fibers as they are being produced in an amount sufficient to effect intrafiber crosslinking. The amount applied to the cellulosic fibers may be from about 1% to about 25% by weight based on the total weight of fibers. In one embodiment, crosslinking agent in an amount from about 4% to about 6% by weight based on the total weight of fibers. Mixtures or blends of crosslinking agents and catalysts can also be used.

Still referring to FIG. 1, the paperboard blank 10 comprises an elongated, trapezoidally-shaped member cut from a sheet of paperboard. The blank 10 has side edges 12 and 14 that slope downwardly and toward each other from the ends of the upper edge 16 of the blank. The upper edge 16 is convex in shape. The lower edge 18 of the blank 10 is concave in shape. When the blank 10 is wrapped in a circle by a conventional container or paper cup manufacturing machine, the portions adjacent to edges 12 and 14 are overlapped and adhesively secured to each other to form the side of the paper cup. The portion of the blank adjacent the upper edge 16 is curled outwardly and downwardly upon itself to form the upper lip of the container such as a paper cup. The bottom edge is adhered to a bottom blank that is not shown in this view.

In accordance with the present invention, the strips 12a and 14a along at least one of the edge portions 12 and 14, and the strip 16a adjacent the upper edge 16 are compressed to a thickness less than the original thickness of the paperboard blank. Usually these compressed strips are on the order of 5 to 9 mm wide. Referring conjunctively to FIG. 1A, the right hand edge 14 shown with a strip 14a adjacent thereto that is compressed to a thickness t that is less than the original thickness T of the paperboard blank.

Because the paperboard blank is produced from a single or multiple ply paperboard in which at least one of the plies contains a cross-linked fiber such as the fiber described above, the strip 14a can be easily compressed to a depth of on the order of 40-60% of the original thickness T. It has been found, however, that the paperboard made from cross-linked fibers tend to rebound somewhat so that when the material is compressed to a thickness originally on the order of 40-60% of the original thickness T, the paperboard with rebound to a thickness on the order of 70-80% of the original thickness T. The amount of rebound, of course, depends upon the amount of cross-linked fiber in the paperboard, with the amount of rebound lessening with a lesser amount of cross-linked fiber in the paperboard.

A typical 3-ply paperboard, in which the mid-ply has on the order of 35-45% cross-linked fiber, based on the total dry weight of the board, will have a thickness on the order of 0.89 mm. When the material is compressed to approximately 0.46 mm, the material will rebound to a thickness of on the order of 0.56-0.76 mm, and usually to about 0.66 mm. This will result in an overall thickness reduction of about 25% when compared to the original thickness T of the paperboard.

The blank shown in FIG. 1 is formed into a container such as a cup on a conventional cup making machine. Such machines are manufactured by Paper Machinery Corp., 8900 West Bradley Road, Milwaukee, Wis., USA. The cup making machine may be adapted to provide for a press roller or platen that will compress strips of the paperboard adjacent the side edges and top edge of the cup. One of ordinary skill will readily be able to adapt a conventional cup making machine to form the compressed strips in accordance with the present invention.

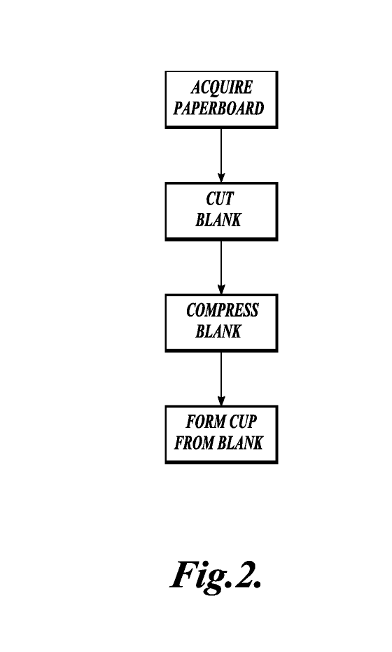

Referring to FIG. 2, the cup is made by first cutting the blank to the desired shape from paperboard stock containing cross-linked fiber. The regions of the cup adjacent the top and side edges are then compressed to form strips of compressed material lying along the respective edges. The cup making machine then folds the blank to form the cup and adheres the overlapping side strips and subsequently curls the upper edge strip to form the lip. A cup bottom is thereafter joined to the sidewalls in a conventional manner. In accordance with the present invention, the blank may be formed with a compressed strip adjacent only one of the side edges, or adjacent both of the side edges. Alternately, the compressed strip adjacent the upper edge of the cup may be formed alone, without forming compressed strips along the side edges. Or the compressed strip along the top edge may be formed in conjunction with one or more compressed strips along the side edges. Forming a compressed strip along all of the side edges and upper edge provides an optimum paper cup that has insulating characteristics but has a less bulky side seam and a less bulky lip thereon. The paperboard can be compressed with a compression force ranging from 4 kPa to 25 kPa or more and at temperatures ranging from 25° C. to 200° C. The board moisture content can also vary from about 3% to about 10% without significantly varying the compressibility or the rebounding or resilient characteristic of the paperboard.

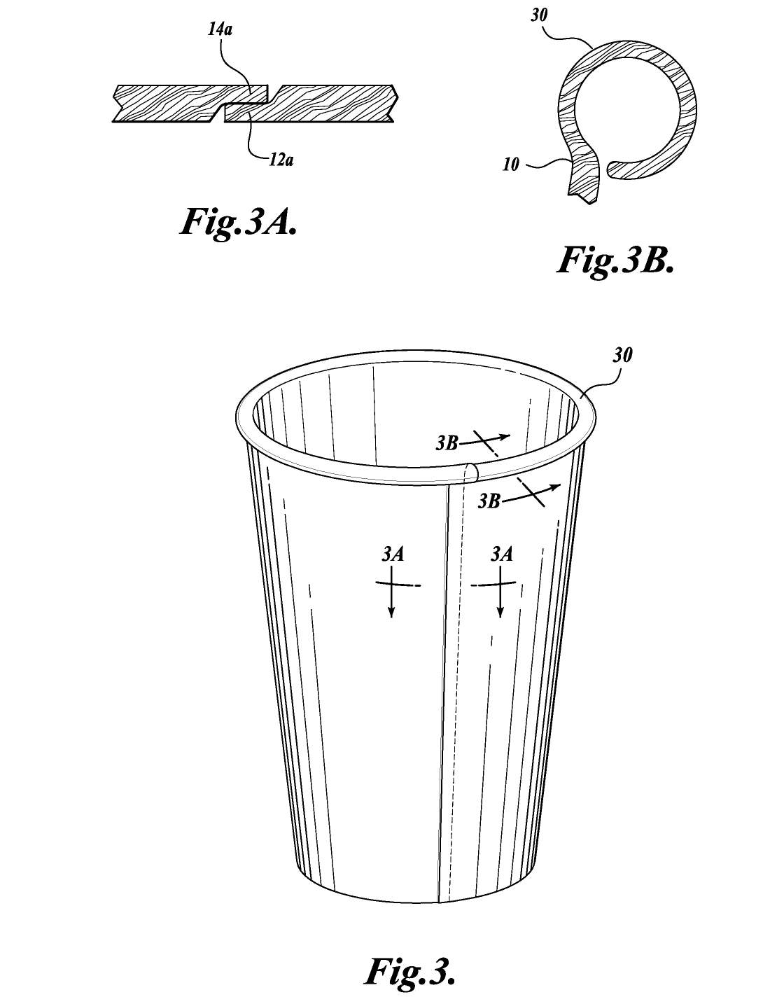

Referring to FIG. 3, a cup made in accordance with the invention is illustrated having an upper lip 30 formed from paperboard in which a strip of material adjacent the upper edge of the cup has been compressed. Referring to FIG. 3B, a cross-section of the upper lip is shown in which the lip 30 has a thickness less than the original thickness of the sidewalls of the board 10. Similarly, the paper cup shown in FIG. 3 has a side seam formed from overlapped edge strips 12a and 14a. The strips of compressed material adjacent the edges 12 and 14 are overlapped and adhere to each other in a conventional manner. This construction provides an overlapped side seam that has a thickness equal to or slightly greater than the original thickness of the paperboard.

### EXAMPLE

The following example is intended to illustrate the compressibility of a paperboard having at least one ply containing cross-linked fibers, such as polyacrylic or citric acid cross-linked cellulose fiber available from The Weyerhaeuser Company. In accordance with the test procedure, two three-ply paperboard samples, A and B, were produced in a conventional manner, as described above. The composition of the paperboards A and B are set forth in Table 1, below.

TABLE 1

| | Paperboard A | Paperboard B |
|---|---|---|
| Top ply fiber | 20 weight % (100% 475 CSF | 20 weight % (100% 475 CSF Pine) |
| | Pine) | |
| Mid ply fiber | 65 weight % (40% 475 CSF | 65 weight % of board (40% 475 |
| | Douglas Fir:60% cross-linked | CSF Douglas Fir:60% cross-linked |
| | fiber) | fiber) |
| Mid ply PVOH | 10% solids on dry weight of | 10% solids on dry weight of midply |
| | midply | |
| Bottom ply fiber | 15 weight % of board (30% 625 | 15 weight % of board (30% 650 |
| | CSF Douglas Fir:70% 475 CSF | CSF Douglas Fir:70% 475 CSF |
| | Pine) | Pine) |

The noncross-linked fibers in the pulp are refined to the stated Canadian Standard Freeness (CSF). The weight percentages are based on the total dry fiber weight of the board. The polyvinyl alcohol (PVOH) (Celvol 165 SF from Celanese Corporation, Dallas, Tex.) is added in the weight percentage based on the dry fiber weight of the midply. In addition, samples of each of the paperboards A and B were made varying amounts of additives, as set forth in Table 2. Aquapel is a trademark of Hercules Incorporated for as sizing agent. Hercobond is a trademark of Hercules Incorporated for anionic polyacrylamide retention aid. It was found that varying the additives had very little effect on the final compressibility and resiliency of the paperboard blank after compressing.

TABLE 2

| | PAPERBOARD A | | | PAPERBOARD B | | |
|---|---|---|---|---|---|---|
| | TOP | MID | BOTTOM | TOP | MID | BOTTOM |
| Additives (g/kg) | Trial 6 | | | Trial 7 | | |
| Aquapel | 2.25 | 2.25 | 2.3 | 4.5 | 4.5 | 4.5 |
| Kymene | 1.5 | 2.5 | 1.5 | 1.5 | 2.5 | 1.5 |
| Cationic Starch | 4 | 5 | 4 | 7.5 | 7.5 | 7.5 |
| Hercobond | 0 | 1 | 0 | 0 | 1 | 0 |
| Silica | .25 | .25 | .25 | 1–1.5 | 1–1.5 | 1–1.5 |
| Dye | 0.03–0.09 | 0 | 0.03–0.09 | 0.03–0.09 | 0 | 0.03–0.09 |

Multiple specimens of paperboards A and B were made by cutting samples into 10.1 cm. by 20.3 cm. rectangles. Compression tests were run on strips 2.54 cm. wide adjacent the longitudinal edges of the test specimens. Caliper test points were marked at spaced locations along each of the strips. One third of the samples for each of the paperboards A and B were conditioned at 20%, 50%, and 65% relative humidity for a minimum of 24 hours. The initial calipers were measured on the strips on each of the samples. The samples were then placed in position on the bottom bar of a platen at ambient temperature with the top ply facing upwardly. A press bar was then heated during multiple runs to predetermined temperatures of about 25.5° C., about 139.1° C., and about 188.8° C. Compression forces of 4922 kPa, 9852 kPa, 17724 kPa, and 24618 kPa were used. A hot press bar, approximately 2.54 cm. wide, was pressed down onto the paperboard lying on the bottom bar. Multiple specimens were then compressed at each of the different temperatures, pressures, and different relative humidities. It was found that higher compression forces, higher temperatures and higher relative humidities led to slightly higher compressibility, resulting in a lesser thickness. The higher temperatures, pressures, and relative humidities provided a final thickness that was about 5-10% less than compression at the lower temperatures, pressures, and relative humidities.

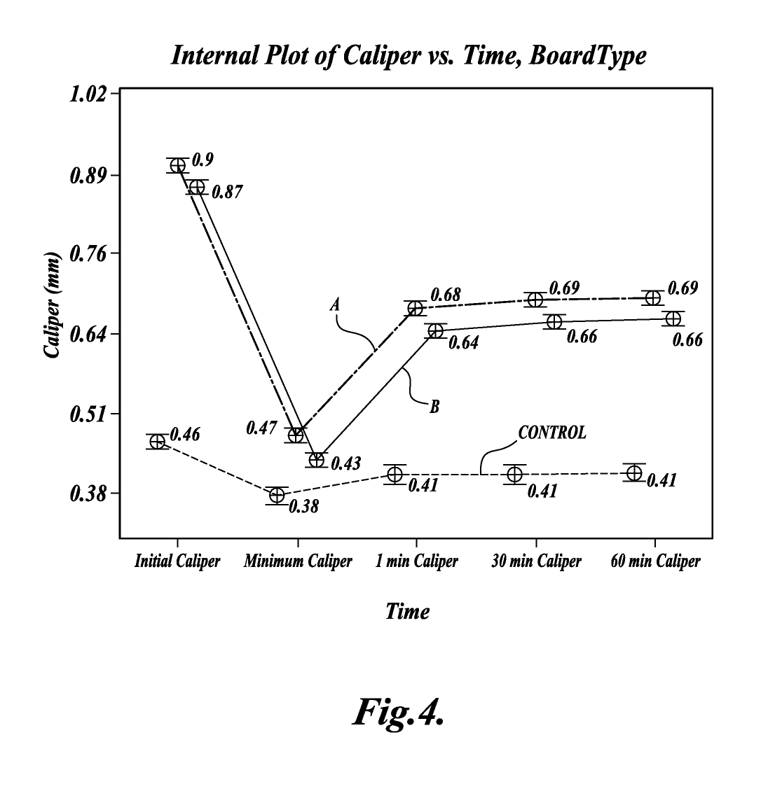

A standard paperboard containing no cross-linked fiber was similarly compressed as a control. The standard paperboard had an initial thickness of 0.46 mm, while the average thicknesses of the paperboard A was about 0.90 mm, and of paperboard B about 0.87 mm. The minimum caliper at full compression was measured, as well as the caliper 1 minute, 30 minutes, and 60 minutes after the compression bar was released. The results of the trials were averaged and are set forth in FIG. 4.

It can be seen by reference to FIG. 4 that the standard paperboard compressed from about 0.46 to 0.38 mm, and then rebounded to about 0.41 mm. The paperboards A and B, produced in accordance with the present invention, were compressed originally from about 0.89 mm to about 0.43-0.46 mm. These then rebounded, respectively, to about 0.64-0.69 mm.

While illustrative embodiments have been illustrated and described, it will be appreciated that various changes can be made therein without departing from the spirit and scope of the invention.

The embodiments of the invention in which an exclusive property or privilege is claimed are defined as follows:

1. A blank for forming a container, comprising:
an insulating paperboard blank comprising cross-linked fibers, said paperboard blank having a predetermined thickness, said paperboard blank having side edges, a top edge, and a bottom edge, said blank adjacent at least one of said edges being compressed to a thickness less than said predetermined thickness.

2. The blank of claim 1, wherein the paperboard blank is compressed along both of said side edges to a thickness less than said predetermined thickness.

3. The blank of claim 2, wherein the paperboard blank adjacent said top edge is compressed to a thickness less than said predetermined thickness.

4. The blank of claim 1, wherein the paperboard blank adjacent said top edge is compressed to a thickness less than the predetermined thickness.

5. A method for forming a container from a paperboard blank, comprising:
forming and cutting an insulating paperboard blank comprising cross-linked fibers from a sheet of paperboard, said paperboard blank having a predetermined thickness, said paperboard blank having side edges, a top edge and a bottom edge;
compressing said paperboard blank adjacent at least one of said edges to form a strip of paperboard having a thickness less than said predetermined thickness; and
forming a container from said blank including a curled lip.

6. The method of claim 5, further comprising:
compressing said blank adjacent at least one of said side edges to form a side strip having a thickness less than said predetermined thickness; and
forming a container wherein said compressed strip adjacent said one side edge is overlapped with the paperboard adjacent the other side edge and adhered thereto.

7. The method of claim 6, further comprising:
compressing said paperboard blank adjacent said other side edge to form a second compressed strip having a thickness less than said predetermined thickness; and
forming a cup by overlapping the compressed strips adjacent said side edges and adhering the compressed strips to each other to form the sidewalls of the cup.

8. The method of claim 6 or 7 further comprising:
compressing said paperboard blank adjacent said top edge, and
curling the compressed area adjacent the top edge to form said lip.

9. A container comprising:
an insulating paperboard blank comprising cross-linked fibers formed into a container, said blank having first and second side edges, a top edge, and a bottom edge, the strip of material adjacent at least one of said top edge, said first side edge, and said second side edge being compressed along the length thereof, the regions adjacent the side edges being overlapped and adhered to each other to form a side seam, the strip adjacent said upper edge being curled to form a lip.

10. The container of claim 9, wherein each of the strips adjacent the top edge and adjacent the first side edge and the second side edge are compressed to a thickness less than the thickness of the paperboard blank.

11. The container of claim 9 wherein the strips adjacent the top edge and at least one of the side edges is compressed.
